(19) United States
(12) Patent Application Publication
(10) Pub. No.: US 2026/0170661 A1
(43) Pub. Date: Jun. 18, 2026

(54) IMAGE DATA STREAM PROCESSING METHOD AND APPARATUS, AND ELECTRONIC DEVICE

(71) Applicant: BEIJING BYTEDANCE NETWORK TECHNOLOGY CO., LTD., Beijing (CN)

(72) Inventor: Xiaoqian WANG, Beijing (CN)

(21) Appl. No.: 18/708,131

(22) PCT Filed: Nov. 8, 2022
(86) PCT No.: PCT/CN2022/130583

§ 371 Date: May 7, 2024

(30) Foreign Application Priority Data
Nov. 9, 2021 (CN) 202111318933.1

(51) Int. Cl. G06T 7/20; G06T 3/40; G06T 7/11

(52) U.S. Cl. CPC G06T 7/20; G06T 3/40; G06T 7/11; G06T 2207/10016; G06T 2207/20081; G06T 2207/20084; G06T 2207/30196

(57) ABSTRACT

An image data stream processing method and apparatus, and an electronic device. The processing method comprises: acquiring an image data stream captured in real time; inputting an image to be processed in the image data stream into a target object flow model, and acquiring a first processing parameter output by the target object flow model for the image to be processed; processing the image to be processed on the basis of the first processing parameter, to obtain a target image; and replacing the image to be processed in the image data stream with the target image, so as to update the image data stream. The first processing parameter comprises at least one first object region, and a flow direction of each first object region.

### CROSS-REFERENCE TO RELATED APPLICATIONS

This application claims priority to and is based on Chinese Application Number 202111318933.1 filed on Nov. 9, 2021, the aforementioned application is hereby incorporated by reference in its entirety.

### FIELD OF THE INVENTION

The invention relates to the technical field of image processing, in particular to method, apparatus, and electronic device for processing an image data stream.

### BACKGROUND

At present, there are objects such as hair, clothes, etc. in some images, and these objects are in a flow state in the actual scene, when it is necessary to present the flow effects of these objects in a process of obtaining an image data stream in real time, a method of generating flow effects for these objects based on the image data stream is urgently needed.

### DISCLOSURE OF THE INVENTION

In order to solve or at least partially solve the above technical problems, the present disclosure provides a method, an apparatus and an electronic device for processing an image data stream. An image data stream with some object flow effects can be generated.

In order to achieve the above objects, the technical solutions provided by embodiments of the present disclosure are as follows:

In a first aspect, there is provided a method for processing an image data stream, comprising:
acquiring an image data stream shot in real time;
inputting an image to be processed in the image data stream into a target object flow model to acquire a first processing parameter output by the target object flow model for the image to be processed, wherein the first processing parameter includes at least one first object region and a flow direction of each first object region;
processing the image to be processed based on the first processing parameter to obtain a target image;
replacing the image to be processed in the image data stream with the target image to update the image data stream.

In a second aspect, there is provided an apparatus for processing an image data stream, comprising:
an acquisition module configured to acquire an image data stream shot in real time; input an image to be processed in the image data stream into a target object flow model to acquire a first processing parameter output by the target object flow model for the image to be processed, wherein the first processing parameter includes at least one first object region and a flow direction of each first object region;
a processing module configured to process the image to be processed based on the first processing parameter to obtain a target image; replace the image to be processed in the image data stream with the target image to update the image data stream.

In a third aspect, there is provided an electronic device, which includes a processor and a memory, wherein a computer program is stored on the memory, and the computer program, when executed by the processor, causes implementation of the method for processing an image data stream as in the first aspect or any embodiment of the present disclosure.

In a fourth aspect, there is provided a computer-readable storage medium, including: a computer program stored on the computer-readable storage medium, which, when executed by a processor, causes implementation of the method for processing an image data stream as in the first aspect or any embodiment of the present disclosure.
In a fifth aspect, there is provided a computer program product, wherein, the computer program product, when executed on a computer, causes the computer to implement the method for processing an image data stream as in the first aspect or any embodiment of the present disclosure.

In a sixth aspect, there is provided a computer program including program codes which, when executed on a computer, causes the computer to implement the method for processing an image data stream as in the first aspect or any embodiment of the present disclosure.

### DESCRIPTION OF THE DRAWINGS

The accompanying drawings, which are incorporated in and constitute a part of the present specification, illustrate embodiments of the present disclosure, and explain the principles of the present disclosure together with the specification.

In order to more clearly illustrate the embodiments of the present disclosure or technical solutions in the prior art, the drawings needed to be used in the description of the embodiments or the prior art will be briefly introduced below, obviously, for those of ordinary skill in the art, other drawings can be obtained based on these drawings without paying any creative labor.

FIG. 1 is a schematic diagram of an application scenario for a method for processing an image data stream according to an embodiment of the present disclosure;

FIG. 2 is a schematic flowchart of a method for processing an image data stream according to an embodiment of the present disclosure;

FIG. 3 is a schematic diagram of an object flow model training process and application process according to an embodiment of the present disclosure;

FIG. 4 is a structural block diagram of an apparatus for processing an image data stream according to an embodiment of the present disclosure;

FIG. 5 is a schematic structural diagram of an electronic device according to an embodiment of the present disclosure.

### DETAILED DESCRIPTION OF PREFERRED EMBODIMENTS

In order to be able to understand the above objects, features and advantages of the present disclosure more clearly, the solutions of the present disclosure will be further described below. It should be noted that the embodiments of the present disclosure and the features in the embodiments can be combined with each other without conflict.

In the following description, numerous specific details are set forth in order to provide a thorough understanding of the present disclosure, but the present disclosure may be practiced in other ways than as described herein; obviously, the embodiments in the specification are only a part of the embodiments of the present disclosure, but not all of the embodiments.

The terms such as ‘first’ and ‘second’ are only used to distinguish different objects, without being used to describe specific orders of objects. For example, the first image and the second image are used to distinguish different images, instead of describing the specific order of images.

In some embodiments, in some applications without image processing functionalities, a display special effect can be realized to make an object region in the image to flow, in a specific implementation process, the user needs to manually select an object region in the selected image, set information, such as a flow direction, etc., for the object, and then generate a corresponding video with object flow effects based on the image in which the object region is manually selected and the flow direction for the object is set, in the process of image processing, since it is necessary to manually select the object region and set the flow direction for the object, the implementation of the image processing process is highly complex.

In order to solve the above problems, an embodiment of the present disclosure provides a method for processing an image data stream, the method can predict the processing parameters (object region and flow direction) corresponding to an object in the image data stream based on a target object flow model, and process the object in the image data stream based on the predicted processing parameters, so that an image data stream with object flow effect can be obtained, compared with manually selecting the object region and setting the flow direction for the object, the implementation complexity of the flow effect processing process can be reduced.

Further, because this method can process the images in an image data stream shot in real time, it can be applied to perform the flow effect processing for some objects in the image data stream in the real-time shooting process.

The method for processing an image data stream can be applied to an apparatus or electronic device for processing an image data stream, and the apparatus for processing an image data stream can be a functional module or functional entity in the electronic device that can realize the method for processing the image data stream.

The above-mentioned electronic device can be a server, a tablet computer, a mobile phone, a notebook computer, a palm computer, a vehicle terminal, a wearable device, an ultra-mobile personal computer (UMPC), a netbook, a personal digital assistant (PDA), a personal computer (PC), etc., which are not specifically limited by embodiments of the present disclosure.

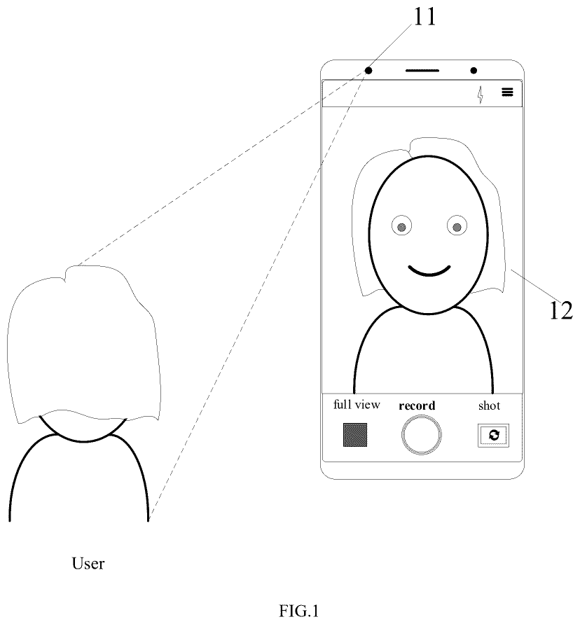

FIG. 1 is a schematic diagram of an application scenario for a method for processing an image data stream according to an embodiment of the present disclosure, the method can be applied to a scenario where a front camera 11 is used to take a selfie video, an image data stream can be acquired through the front camera 11 in real time, and after an image in the image data stream is processed in accordance with an object flow model provided by an embodiment of the present disclosure, the processed image data stream is presented in an interface of a terminal device, so as to obtain a real-time video picture 12, as shown in FIG. 1.

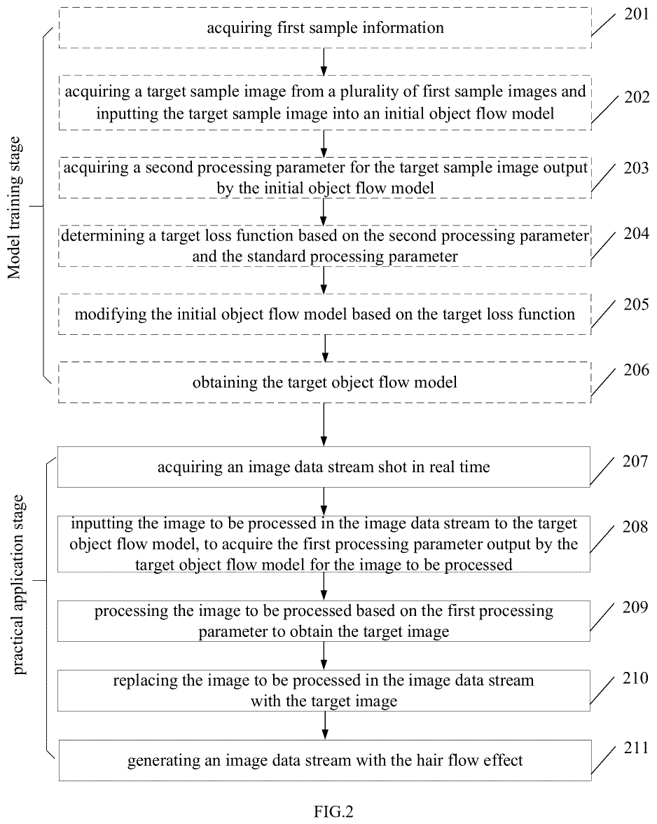

As shown in FIG. 2, which is a schematic flowchart of a method for processing an image data stream according to an embodiment of the present disclosure, the method may include two stages: a model training stage and a practical application stage, including:
The model training stage may include the following steps 201 to 206.
201. acquiring first sample information.

Wherein, the first sample information includes a plurality of first sample images and a standard processing parameter for each first sample image; the standard processing parameter may include at least one object region, a flow direction of each object region, and a flow velocity of each object region.

In an embodiment of the present disclosure, an object may be hair, and may also be clothing, water flow, etc. As an example, the above object region may refer to a region in the image where hair is located, and can be referred to as a hair region in an embodiment of the present disclosure.

In some embodiments, acquiring first sample information includes acquiring an original image; performing geometric transformation and/or color transformation on the original image to obtain at least one transformed image; the original image and at least one transformed image are taken as first sample images in the first sample information.

In the actual model training process, in order to represent the accuracy of the model, a large number of image data are needed as training samples, so it is necessary to make full use of the existing images to perform data enhancement so as to obtain more training samples. The data enhancement also can be referred to as data expansion, which means making limited data to produce values equivalent to more data without substantially increasing data, when the data enhancement is utilized to enhance a sample image, it can perform geometric transformation and/or color transformation on the sample image to obtain a plurality of enhanced images.

Among them, the geometric transformation operation does not change the contents of the image itself. The geometric transformation can include at least one of flipping, rotating, cropping, deforming and scaling.

In an embodiment of the present disclosure, for a case where an object region has such a small proportion that it cannot be divided accurately in a multiple person scenario, it is proposed to perform geometric transformation, such as random scaling, random cropping, etc., on an image, and taking the transformed image as a first sample image in the first sample information, which can improve accuracy of a subsequently-trained target object flow model for recognizing object regions with different sizes and different positions.

In an embodiment of the present disclosure, for a case where an object involved in an embodiment of the present disclosure is hair, based on a situation that the hair flow direction is an unidirectional direction, or is different from the hair growth direction, or the like, it is proposed to randomly rotate the image, and take the randomly rotated image as the first sample image in the first sample information, which can improve the robustness of the subsequently-trained target object flow model with respect to different flow directions.

The above-mentioned random flipping and random rotation will not change the size of the image, while the random cropping will change the size of the image due to cropping out a part of contents of the original image, and the image obtained after cropping will be smaller than the original image.

Among them, color transformation can include at least one of noise addition and color disturbance. The data enhancement by color transformation generally changes the contents of the image.

In some embodiments, data enhancement based on noise addition is to overlap some noises, most commonly Gaussian noises, randomly on the basis of the original image. In some implementations, some pixels can be discarded in a rectangular region with a selectable area size and a random position, so that the image can produce some color noises.

Color disturbance is to change the color of the original image by increasing or decreasing some color components or changing the order of color channels in a certain color space, so as to obtain a variety of images after color change.

Further, a down-sampling operation can be performed based on original images, and an object flow model can be trained based on the small-size images acquired by the down-sampling operation, which can reduce calculation complexity and time consumption for the model in the training process.

Down-sampling of an image can be understood as: down-sampling a resolution image with an image size of M*N by s times, that is, acquiring a resolution image with an image size of (M/s)*(N/s), where s is the common divisor of M and N. In the process of down-sampling, every image of s*s pixels of the original image are turned into a pixel, and the value of this pixel can be an average value of all pixels in the window. In an embodiment of the present disclosure, acquiring the first sample information may include two manners, one is to acquire the first sample information by manual labelling, the other is to acquire the first sample information by means of an object segmentation model and an image flow model.

In some embodiments of the present disclosure, when acquiring the first sample information, a plurality of first sample images may be images based on self-owned image resources and images obtained by data enhancement based on existing image resources. When acquiring the standard processing parameter for each first sample image, an object region mask can be labelled based on each first sample image by manual labelling to obtain the object region of each sample image, and the vectors of flow direction and flow velocity in the flow region of each first sample image can be labelled by manual labelling to obtain the flow direction and flow velocity in the flow region of each first sample image.

To reduce manual labelling cost, for a scenario where some persons take a selfie and some persons are shot by others, an embodiment of the present disclosure can acquire an object region mask through an object segmentation model, and generate motion (vector) information containing an object flow direction and an object flow velocity by means of an image flow model.

In some embodiments, the acquiring the first sample information may include the following steps:
(1) acquiring an original image.
(2) inputting the original image into an object segmentation model and acquiring at least one second object region of the original image output by the object segmentation model.

Wherein, the object segmentation model is a neural network model trained based on second sample information, and the second sample information may include a plurality of second sample images and an object region corresponding to each second sample image.
(3) inputting the original image into a target image flow model (the trained image flow model), and acquiring the first flow parameter for the original image output by the target image flow model.

The first flow parameter may include at least one flow region, the flow direction of each flow region and the flow velocity of each flow region; the target image flow model is a neural network model trained based on third sample information, which may include a plurality of third sample images and the standard flow parameter of each third sample image.
(4) in accordance with at least one second object region in the original image and the first flow parameter, determining the flow direction and the flow velocity of each second object region.
(5) taking the original image as the first sample image in the first sample information, and taking at least one second object region, the flow direction of each second object region and the flow velocity of each second object region as the standard processing parameter for the first sample image.

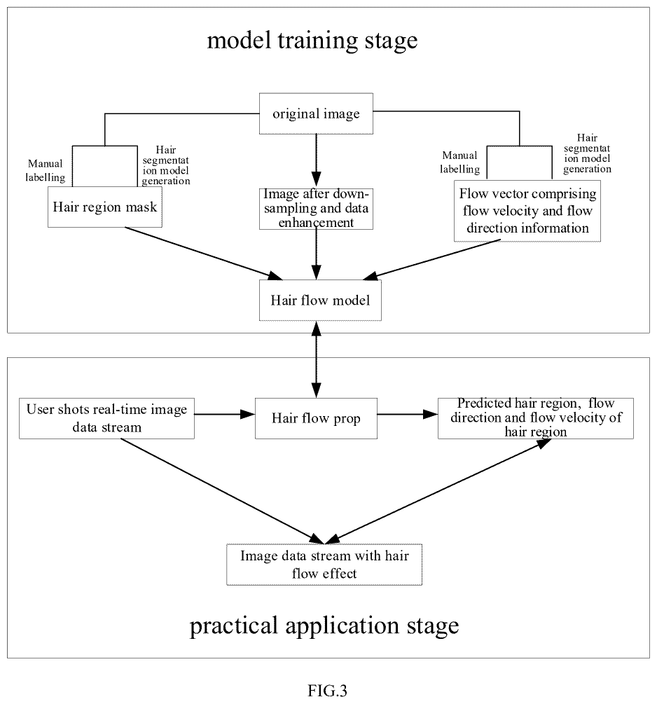

Illustratively, as shown in FIG. 3, which is a schematic diagram of an object flow model training process and application process, it can be seen from FIG. 3 that an object region mask can be generated according to the original image through manual labeling or the object segmentation model, so that an object region corresponding to the original image can be acquired, and/or a flow vector containing flow velocity and flow direction information can also be generated through manual labeling or the image flow model, so that the flow direction and flow velocity of each object region can be acquired, and then the object flow model can be trained with these information as sample information.
202. acquiring a target sample image from a plurality of first sample images and inputting the target sample image into an initial object flow model.

Among them, the above target sample image can be any one of a plurality of first sample images.
203. acquiring a second processing parameter for the target sample image output by the initial object flow model.

Among them, the second processing parameter may include at least one flow region of the target sample image, and the flow direction and flow velocity of each flow region.
204. determining a target loss function based on the second processing parameter and the standard processing parameter.
205. modifying the initial object flow model based on a target loss function.

The target loss function may include at least one of the following: cross entropy loss function, total variation loss function, dice loss function, focal loss function, L1 regular loss function.

In an embodiment of the present disclosure, in order to ensure accuracy of the algorithm, the cross-entropy loss function, the total variation loss function and the L1 canonical loss function can be weight combined to supervise the prediction of the object region, flow direction and flow velocity in the object flow model.

The above-mentioned dice loss function, focal loss function mainly act on the accuracy of identifying the object region, so in some embodiments, setting the weights for the dice loss function and focal loss function higher can improve the prediction accuracy for the object region, while the L1 canonical loss function mainly acts on the accuracy of the flow vector (flow velocity and flow direction), so setting the weight for the L1 canonical loss function higher can improve the prediction accuracy of the flow vector.
206. Loop the above steps 202 to 205 at least once to obtain the target object flow model.

According to an embodiment of the present disclosure, the number of loops in the training process of the target object flow model as mentioned above can be appropriately determined in any way. For example, it can be preset to a specific value, or it can be dynamically set according to the training result. As an example, the processing results of the model can be analyzed during the training process, and when the processing results meet certain conditions, such as processing accuracy meets requirements, prediction results meet requirements, and so on, the training process can be terminated to obtain the target object flow model. As another example, the training process can be terminated after a certain number of loops, and the target object flow model can be obtained. The number of training processes can also be set in an appropriate way in the art, which will not be described in detail here.

In an embodiment of the present disclosure, the target object flow model may be a neural network model. In some embodiments, the target object flow model is an object flow model with less number of parameters and small amount of calculation which is based on GhostNet algorithm and derived in combination with U-Net model, and such model can satisfy an application scenario of generating flow effects in real time. Due to small amount of calculation and less number of parameters, the model is suitable for an application on the terminal side, that is, the target object flow model can be configured in a terminal device.

In some embodiments, the above target object flow model may include multiple down-sampling operations and/or multiple convolution operations.

In some embodiments, when configuring multiple down-sampling operations and operation-related parameters in the target object flow model, different operation-related parameters can be set for adjacent down-sampling operations.

In some embodiments, when configuring operation-related parameters for multiple convolution operations in the target object flow model, different operation-related parameters can be set for adjacent convolution operations.

The operation-related parameter may include at least one of kernel size, dilation coefficient and stride.

That is, at least one of the down-sampling kernel size, down-sampling dilation coefficient and down-sampling stride can be set differently for adjacent down-sampling operations; at least one of the convolution kernel size, convolution dilation coefficient, and convolution stride can also be set differently for adjacent convolution operations. In an embodiment of the present disclosure, different operation-related parameters are set for the adjacent down-sampling operations or convolution operations in the model network, which can avoid a gridding effect caused by processing the image data at a fixed position every time when the down-sampling operation or convolution operation is performed, and improve the gridding effect problem occurring in the predicted flow region mask.

The practical application stage includes the following steps 207 to 211.
207. acquiring an image data stream shot in real time.

As shown in FIG. 3, assuming that the object involved in an embodiment of the present disclosure is hair, the user can trigger the usage of a hair flow prop to shoot a video with hair flow effects upon shooting an image data stream with an electronic device, and when the hair flow prop is triggered, the trained hair flow model (i.e., the target object flow model) will be invoked to process the images in the image data stream acquired by the user in real time and predict the corresponding processing parameters.
208. inputting the image to be processed in the image data stream to the target object flow model, to acquire the first processing parameter output by the target object flow model for the image to be processed.

The above-mentioned image to be processed can be any frame in the image data stream, in an embodiment of the present disclosure, the images in the image data stream can be sequentially processed as the image to be processed in the order of acquiring the images when the image data stream is shot, that is, steps 208 to 210 can be performed on the images in the image data stream, so that the image data stream with object flow effects can be generated.

Among them, the first processing parameter may include at least one first object region, the flow direction of each first object region and the flow velocity of each first object region.

In some embodiments, inputting the image to be processed in the image data stream to the target object flow model, may include: acquiring the image to be processed from the image data stream; down-sampling the image to be processed to obtain the down-sampled image to be processed; inputting the down-sampled image to be processed into the target object flow model.

For example, for a scenario where a user shoots a scene in real time, the image to be processed can be down-sampled and converted into a small-size image, so that the calculation amount and time consumption of the target object flow model can be reduced.

In some embodiments, the first processing parameter may not include the flow velocity, in which case the target object flow model may not predict the flow velocity, and the flow velocity may be a default fixed flow velocity.
209. processing the image to be processed based on the first processing parameter to obtain the target image.

In some embodiments, a minimum circumscribed rectangular region for each first object region can be determined in the image to be processed; in the minimum circumscribed rectangular region of each first object region, the image to be processed is processed according to the flow direction and velocity of each first object region to obtain the target image.

In an embodiment of the present disclosure, when the object is hair, the above target object flow model is a target hair flow model, and the above first object region is a first hair region.

For an image data stream shot and uploaded by a user in real time, the embodiment of the present disclosure first predicts its object regions and flow vectors through the target object flow model. In order to save time consumption, the picture is deformed in the minimum circumscribed rectangular for the object region.

In order to prevent a non-object region from flowing, the object flow velocity is limited with respect to regions and levels. Specifically, when the first image is processed based on the first processing parameter, the flow velocity of the edge region can be restricted to be less than that of the central region in each first object region.

Further, it is also possible to set different flow velocity ranges for the edge region and the central region in the object region, and restrict the flow velocity of the edge region in each object region and the flow velocity of the central region in each object region based on the corresponding flow velocity ranges respectively.
210. replacing the image to be processed in the image data stream with the target image to update the image data.

As shown in FIG. 3, based on the image to be processed in the image data stream and the hair flow model, it can be predicted at least one first hair region in the image to be processed, and the flow direction and flow velocity of each first hair region, further, the image to be processed can be processed based on these predicted information so as to obtain a target image, and by replacing the image to be processed in the image data stream with the target image, the image data stream can be updated to obtain an image data stream with the hair flow effect.
211. generating an image data stream with the hair flow effect.

The method for processing an image data stream according to an embodiment of the present disclosure can acquire an image data stream shot in real time; input an image to be processed in the image data stream into a target object flow model to acquire a first processing parameter output by the target object flow model for the image to be processed, wherein the first processing parameter includes at least one first object region and a flow direction of each first object region; wherein the target object flow model is a neutral network model; process the image to be processed based on the first processing parameter to obtain a target image; replace the image to be processed in the image data stream with the target image to update the image data stream. Through this scheme, since the processing parameters (object region and flow direction) corresponding to images in the image data stream can be predicted based on the target object flow model, and the images in the image data stream can be processed based on the predicted processing parameters, so that an image data stream with object flow effects can be obtained, and thus the image data stream with certain object flow effects can be generated.

It should be pointed out that the model training process/model training stage as described above, especially steps 201-206, is optional for the scheme of the present disclosure. In particular, such a model training process/model training stage can be included in the method for processing an image data stream of the present disclosure, or located outside the method for processing an image data stream of the present disclosure, and acquired and applied by the method for processing an image data stream of the present disclosure. Therefore, it is shown by dotted lines in the drawings. It should be pointed out that even if the model training process/model training stage is not inclusive, the method for processing an image data stream of the present disclosure is still complete, and the aforementioned advantageous technical effects can be achieved.

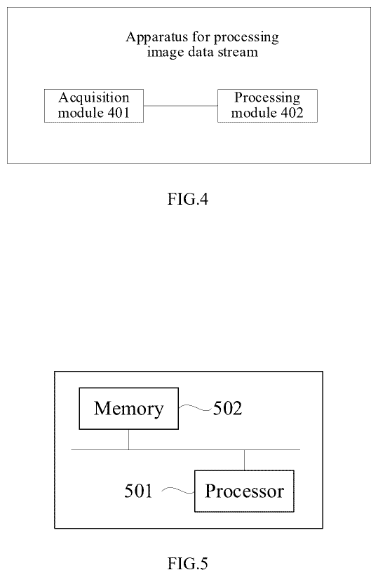

As shown in FIG. 4, an embodiment of the present disclosure provides a schematic diagram of an apparatus for processing an image data stream, which includes:
an acquisition module 401 configured to acquire an image data stream shot in real time; input an image to be processed in the image data stream into a target object flow model to acquire a first processing parameter output by the target object flow model for the image to be processed, wherein the first processing parameter includes at least one first object region and a flow direction of each first object region;
a processing module 402 configured to process the image to be processed based on the first processing parameter to obtain a target image; replace the image to be processed in the image data stream with the target image to update the image data stream.

As an alternative to the embodiment of the present disclosure, the first processing parameter may further include a flow velocity of each first object region.

As an alternative to the embodiment of the present disclosure, the target object flow model is a neural network model trained based on first sample information, which includes a plurality of first sample images and a standard processing parameter for each first sample image;

The acquisition module 401 is further configured to, before inputting an image to be processed in the image data stream into a target object flow model to acquire a first processing parameter output by the target object flow model for the image to be processed:
acquire first sample information;
loop the following steps at least once to obtain the target object flow model:
acquiring a target sample image from a plurality of first sample images and input the target sample image into an initial object flow model;
acquiring a second processing parameter for the target sample image output by the initial flow object model;
determining a target loss function based on the second processing parameter and a standard processing parameter;
modifying the initial object flow model based on the target loss function.

As an alternative to the embodiment of the present disclosure, the target loss function may include at least one of the following: cross entropy loss function, total variation loss function, dice loss function, focal loss function, L1 regular loss function. As an alternative to the embodiment of the present disclosure, the acquisition module 401 is specifically configured to:
acquire an original image;
perform geometric transformation and/or color transformation on the original image to obtain at least one transformed image; and
taking the original image and at least one transformed image as first sample images in the first sample information.

As an alternative to the embodiment of the present disclosure, the geometric transformation may include at least one of flipping, rotating, cropping, deforming and scaling;

As an alternative to the embodiment of the present disclosure, the color transformation may include at least one of noise addition and color disturbance.

As an alternative to the embodiment of the present disclosure, the acquisition module 401 is specifically configured to:
acquiring an original image;
inputting the original image into an object segmentation model and acquiring at least one second object region of the original image output by the object segmentation model, wherein, the object segmentation model is a neural network model trained based on second sample information, and the second sample information may include a plurality of second sample images and an object region corresponding to each second sample image;
inputting the original image into a target image flow model and acquiring the first flow parameter for the original image output by the target image flow model, the first flow parameter may include at least one flow region, the flow direction of each flow region and the flow velocity of each flow region; the target image flow model is a neural network model trained based on third sample information, which may include a plurality of third sample images and the standard flow parameter of each third sample image;
in accordance with at least one second object region in the original image and the first flow parameter, determining the flow direction of each second object region and the flow velocity of each second object region;
taking the original image as the first sample image in the first sample information, and taking at least one second object region, the flow direction of each second object region and the flow velocity of each second object region as the standard processing parameter for the first sample image.

As an alternative to the embodiment of the present disclosure, the acquisition module 401 is specifically configured to:
acquire an image to be processed from an image data stream;
down-sample the image to be processed to obtain the down-sampled image to be processed;
input the down-sampled image to be processed into the target object flow model.

As an alternative to the embodiment of the present disclosure, the processing module 402 is specifically configured to:
determine a minimum circumscribed rectangular region for each first object region in the image to be processed;
in the minimum circumscribed rectangular region for each first object region, process the image to be processed according to the flow direction and flow velocity of each first object region to obtain the target image.

As an alternative to the embodiment of the present disclosure, the flow velocity of the edge region in each first object region is less than the flow velocity of the central region.

As an alternative to the embodiment of the present disclosure, the target object flow model may include multiple down-sampling operations and/or multiple convolution operations,
for adjacent down-sampling operations and/or adjacent convolution operations, operation-related parameters are different;
wherein the operation-related parameter may include at least one of the following:
kernel size, dilation coefficient and stride.

As an alternative to the embodiment of the present disclosure, the target object flow model is derived based on GhostNet algorithm in combined with Semantic Segmentation Network Model (U-Net).

As an alternative to the embodiment of the present disclosure, the target object flow model is a target hair flow model, and the first object region is a first hair region.

It should be noted that each of the above modules only belongs to a logical module classified according to the specific function it implements, instead of limiting its specific implementation manner, for example, it can be implemented in software, hardware, or a combination of software and hardware. In an actual implementation, each of the above modules may be implemented as separate physical entity, or may be implemented by a single entity (for example, a processor (CPU or DSP, etc.), an integrated circuit, etc.). In addition, the above-described modules are shown in the drawings in dash lines to indicate that such modules can not actually exist, the operations/functionalities that they implement can be implemented by the apparatus or a processing circuit itself.

In addition, although not shown, the apparatus may also include a memory that may store various information generated by the apparatus, various modules included in the apparatus during operation, programs and data for operations, data to be sent by the communication unit, etc. The memory may be a volatile memory and/or a non-volatile memory. For example, a memory may include, but is not limited to, random access memory (RAM), dynamic random-access memory (DRAM), static random-access memory (SRAM), read only memory (ROM), and flash memory. Of course, the memory may also be located external to the apparatus.

An embodiment of the present disclosure provides an electronic device, as shown in FIG. 5, which includes a processor 501, and a memory 502, where a computer program can be stored on the memory 502, the computer program, when executed by the processor, implements the method for processing an image data stream involved in the above method embodiments.

An embodiment of the present disclosure provides a computer-readable storage medium on which a computer program is stored, the computer program, when executed by a processor, causes implementation of the method for processing an image data stream involved in the above method embodiments.

Among them, the computer-readable storage medium may be read only Memory (ROM), random access memory (RAM), magnetic disk, or optical disk, and so on.

An embodiment of the present disclosure provides a computer program product, which, when executed on a computer, causes the computer to implement the method for processing an image data stream involved in the above method embodiments.

An embodiment of the present disclosure provides a computer program including program codes which, when executed on a computer, causes the computer to implement the method for processing an image data stream involved in the above method embodiments.

It should be understood by those skilled in the art that embodiments of the present disclosure can be provided as method, system, or computer program product. Therefore, the present disclosure can take the form of an entirely hardware embodiment, an entirely software embodiment, or an embodiment combining software and hardware aspects. Moreover, the present disclosure may take the form of a computer program product embodied on one or more computer usable storage media having computer usable program codes embodied therein.

In the present disclosure, the processor may be a Central Processing Unit (CPU), may also be other general processors, Digital Signal Processor (DSP), application specific integrated circuits (ASIC), Field-Programmable Gate Array (FPGA) or other programmable logic devices, discrete gate or transistor logic devices, discrete hardware components, etc. The general processor can be a microprocessor, or the processor can be any conventional processor, etc.

In the present disclosure, the memory may include non-permanent memory, random access memory (RAM) and/or non-volatile memory in computer-readable media, such as read-only memory (ROM) or flash RAM. Memory can be an example of a computer-readable medium.

In the present disclosure, a computer-readable medium can include permanent and non-permanent, removable and non-removable storage media. The storage medium can store information by any method or technology, and the information can be computer-readable instructions, data structures, program modules or other data. Examples of storage media for computers include, but not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, magnetic cassette tape, magnetic disk storage, or other magnetic storage or any other non-transmission medium, that can be used for storing any information accessible to a computing device. According to the definition in the context of the description, the computer-readable media does not include transitory media, such as modulated data signals and carrier waves.

It should be noted that, relational terms such as ‘first’ and ‘second’ are only used to distinguish one entity or operation from another entity or operation, without requiring or implying such actual relationship or order between such entities or operations. The terms “comprise”, “include” or any other variation thereof are intended to encompass a non-exclusive inclusion, so that a process, method, article, or apparatus comprising a series of elements includes not only those elements, but also other elements not explicitly listed, or elements inherent to such a process, method, article, or apparatus. Without further limitation, the element as defined by the phrase “comprising a” does not preclude presence of additional identical elements in a process, method, article, or apparatus that includes said element.

What has been described above is only a specific implementation of the present disclosure so as to enable those skilled in the art to understand or implement the disclosure. Various modifications to the embodiments will be readily apparent to those skilled in the art, and the generic principles defined herein may be implemented in other embodiments without departing from the spirit or scope of the disclosure. Therefore, the present disclosure is not to be limited to the embodiments set forth herein, but is to be accorded the widest scope consistent with the principles and novel features disclosed herein.

1. A method for processing an image data stream, comprising:
acquiring an image data stream shot in real time;
inputting an image to be processed in the image data stream into a target object flow model to acquire a first processing parameter output by the target object flow model for the image to be processed, wherein the first processing parameter includes at least one first object region and a flow direction of each first object region;
processing the image to be processed based on the first processing parameter to obtain a target image;
replacing the image to be processed in the image data stream with the target image to update the image data stream.

2. The method of claim 1, wherein the first processing parameter further comprises a flow velocity of each first object region.

3. The method of claim 2, wherein the target object flow model is a neural network model trained based on first sample information, which comprises a plurality of first sample images and a standard processing parameter for each first sample image;
before inputting an image to be processed in the image data stream into a target object flow model to acquire a first processing parameter output by the target object flow model for the image to be processed, further comprising:
acquire first sample information;
loop the following steps at least once to obtain the target object flow model:
acquiring a target sample image from a plurality of first sample images to input the target sample image into an initial object flow model;
acquiring a second processing parameter for the target sample image output by the initial flow object model;
determining a target loss function based on the second processing parameter and the standard processing parameter;
modifying the initial object flow model based on the target loss function.

4. The method of claim 3, wherein the acquiring the first sample information comprises:
acquiring an original image;
inputting the original image into an object segmentation model and acquiring at least one second object region of the original image output by the object segmentation model;
inputting the original image into a target image flow model; acquiring a first flow parameter for the original image output by the target image flow model;
in accordance with at least one second object region of the original image and the first flow parameter, determining the flow direction of each second object region and the flow velocity of each second object region;
taking the original image as the first sample image in the first sample information, and taking at least one second object region, the flow direction of each second object region and the flow velocity of each second object region as the standard processing parameter for the first sample image.

5. The method of claim 4, wherein the object segmentation model is a neural network model trained based on second sample information, and the second sample information comprises a plurality of second sample images and an object region corresponding to each second sample image;
the target image flow model is a neural network model trained based on third sample information, which comprises a plurality of third sample images and a standard flow parameter of each third sample image.

6. The method of claim 2, wherein the processing the image to be processed based on the first processing parameter to obtain a target image, comprises:
determining a minimum circumscribed rectangular region for each first object region in the image to be processed;
in the minimum circumscribed rectangular region for each first object region, processing the image to be processed according to the flow direction and flow velocity of each first object region to obtain the target image.

7. The method of claim 1, wherein the target object flow model is derived based on GhostNet algorithm in combined with Semantic Segmentation Network Model (U-Net).

8. The method of claim 1, wherein the inputting an image to be processed in the image data stream into a target object flow model comprises:
acquiring the image to be processed from the image data stream;
down-sampling the image to be processed to obtain the down-sampled image to be processed;
inputting the down-sampled image to be processed into the target object flow model.

9. The method of claim 1, wherein the target object flow model is a target hair flow model, and the first object region is a first hair region.

10. The method of claim 1, wherein the target object flow model is a neural network model.

11. (canceled)

12. An electronic device, comprising a processor and a memory, wherein a computer program is stored in the memory, and wherein the computer program, when executed by the processor, implements:
acquiring an image data stream shot in real time;
inputting an image to be processed in the image data stream into a target object flow model to acquire a first processing parameter output by the target object flow model for the image to be processed, wherein the first processing parameter includes at least one first object region and a flow direction of each first object region;
processing the image to be processed based on the first processing parameter to obtain a target image;
replacing the image to be processed in the image data stream with the target image to update the image data stream.

13. A non-transitory computer-readable storage medium having stored thereon a computer program which, when executed by a processor, implements:
acquiring an image data stream shot in real time;
inputting an image to be processed in the image data stream into a target object flow model to acquire a first processing parameter output by the target object flow model for the image to be processed, wherein the first processing parameter includes at least one first object region and a flow direction of each first object region;
processing the image to be processed based on the first processing parameter to obtain a target image;
replacing the image to be processed in the image data stream with the target image to update the image data stream.

14-15. (canceled)

16. The electronic device of claim 12, wherein the target object flow model is a neural network model trained based on first sample information, which comprises a plurality of first sample images and a standard processing parameter for each first sample image;
wherein the computer program, when executed by the processor, implements: before inputting an image to be processed in the image data stream into a target object flow model to acquire a first processing parameter output by the target object flow model for the image to be processed:
acquire first sample information;
loop the following steps at least once to obtain the target object flow model:
acquiring a target sample image from a plurality of first sample images to input the target sample image into an initial object flow model;
acquiring a second processing parameter for the target sample image output by the initial flow object model;
determining a target loss function based on the second processing parameter and the standard processing parameter;
modifying the initial object flow model based on the target loss function.

17. The electronic device of claim 16, wherein the acquiring the first sample information comprises:
acquiring an original image;
inputting the original image into an object segmentation model and acquiring at least one second object region of the original image output by the object segmentation model;
inputting the original image into a target image flow model; acquiring a first flow parameter for the original image output by the target image flow model;
in accordance with at least one second object region of the original image and the first flow parameter, determining the flow direction of each second object region and the flow velocity of each second object region;
taking the original image as the first sample image in the first sample information, and taking at least one second object region, the flow direction of each second object region and the flow velocity of each second object region as the standard processing parameter for the first sample image.

18. The electronic device of claim 12, wherein the processing the image to be processed based on the first processing parameter to obtain a target image, comprises:
determining a minimum circumscribed rectangular region for each first object region in the image to be processed;
in the minimum circumscribed rectangular region for each first object region, processing the image to be processed according to the flow direction and flow velocity of each first object region to obtain the target image.

19. The electronic device of claim 12, wherein the inputting an image to be processed in the image data stream into a target object flow model comprises:
acquiring the image to be processed from the image data stream;
down-sampling the image to be processed to obtain the down-sampled image to be processed;
inputting the down-sampled image to be processed into the target object flow model.

20. The non-transitory computer-readable storage medium of claim 13, wherein the target object flow model is a neural network model trained based on first sample information, which comprises a plurality of first sample images and a standard processing parameter for each first sample image;
wherein the computer program, when executed by the processor, implements: before inputting an image to be processed in the image data stream into a target object flow model to acquire a first processing parameter output by the target object flow model for the image to be processed:
acquire first sample information;
loop the following steps at least once to obtain the target object flow model:
acquiring a target sample image from a plurality of first sample images to input the target sample image into an initial object flow model;
acquiring a second processing parameter for the target sample image output by the initial flow object model;
determining a target loss function based on the second processing parameter and the standard processing parameter;
modifying the initial object flow model based on the target loss function.

21. The non-transitory computer-readable storage medium of claim 20, wherein the acquiring the first sample information comprises:
acquiring an original image;
inputting the original image into an object segmentation model and acquiring at least one second object region of the original image output by the object segmentation model;
inputting the original image into a target image flow model; acquiring a first flow parameter for the original image output by the target image flow model;
in accordance with at least one second object region of the original image and the first flow parameter, determining the flow direction of each second object region and the flow velocity of each second object region;
taking the original image as the first sample image in the first sample information, and taking at least one second object region, the flow direction of each second object region and the flow velocity of each second object region as the standard processing parameter for the first sample image.

22. The non-transitory computer-readable storage medium of claim 13, wherein the processing the image to be processed based on the first processing parameter to obtain a target image, comprises:
determining a minimum circumscribed rectangular region for each first object region in the image to be processed;
in the minimum circumscribed rectangular region for each first object region, processing the image to be processed according to the flow direction and flow velocity of each first object region to obtain the target image.

23. The non-transitory computer-readable storage medium of claim 13, wherein the inputting an image to be processed in the image data stream into a target object flow model comprises:
acquiring the image to be processed from the image data stream;
down-sampling the image to be processed to obtain the down-sampled image to be processed;
inputting the down-sampled image to be processed into the target object flow model.
